(19) United States
(12) Patent Application Publication
(10) Pub. No.: US 2020/0310779 A1
(43) Pub. Date: Oct. 1, 2020

(54) VALIDATING A FIRMWARE COMPLIANCE POLICY PRIOR TO USE IN A PRODUCTION SYSTEM

(71) Applicant: Lenovo Enterprise Solutions (Singapore) Pte. Ltd., Singapore (SG)

(72) Inventors: Jeffrey John Van Heuklon, Rochester, MN (US); Christopher Anthony Peterson, Richfield, MN (US)

(21) Appl. No.: 16/370,192

(22) Filed: Mar. 29, 2019

(51) Int. Cl. G06F 8/65; G06F 11/36

(52) U.S. Cl. CPC G06F 8/65; G06F 11/3692; G06F 11/3688

(57) ABSTRACT

A method, apparatus and computer program product are provided. The method includes detecting a malfunction of a production node in a computer system, identifying a firmware update that addresses the malfunction of the production node, and determining whether the firmware update is identified in a firmware compliance policy that has been validated for use by the production node. The method further includes automatically installing the firmware update on the production node in response to determining that the firmware update is identified in a firmware compliance policy that has been validated for use by production nodes in the computer system and that the firmware update has not already been installed on the production node. In one option, the firmware compliance policy may be validated by a system management application testing the firmware compliance policy in a test system managed by the system management application.

### BACKGROUND

The present disclosure relates to updating firmware in a node of a computer system.

### BACKGROUND OF THE RELATED ART

Various nodes of a modern computer system use firmware to control important low level functions of a node's hardware. Firmware is often stored in non-volatile memory so that the firmware is available to the node hardware at all times, including during boot up of the node. However, firmware may be occasionally updated in order to fix bugs or introduce new functionality to the node hardware.

While a firmware update may fix bugs or introduce additional functionality to the hardware, the firmware update also has the potential to cause unanticipated changes in the operation of the node. Small differences in the configuration of nodes or the nature of workload being performed by the nodes may lead to the firmware working well in one node or environment yet experiencing a malfunction in another node or environment.

### BRIEF SUMMARY

Some embodiments provide a computer program product comprising a non-volatile computer readable medium and non-transitory program instructions embodied therein, the program instructions being configured to be executable by a processor to cause the processor to perform operations. The operations comprise detecting a malfunction of a production node in a computer system, identifying a firmware update that addresses the malfunction of the production node, and determining whether the firmware update is identified in a firmware compliance policy that has been validated for use by the production node. The operations further comprise automatically installing the firmware update on the production node in response to determining that the firmware update is identified in a firmware compliance policy that has been validated for use by production nodes in the computer system and that the firmware update has not already been installed on the production node.

Some embodiments provide an apparatus comprising at least one non-volatile storage device storing program instructions and at least one processor configured to process the program instructions, wherein the program instructions are configured to, when processed by the at least one processor, cause the apparatus to perform operations. The operations comprise detecting a malfunction of a production node in a computer system, identifying a firmware update that addresses the malfunction of the production node, and determining whether the firmware update is identified in a firmware compliance policy that has been validated for use by the production node. The operations further comprise automatically installing the firmware update on the production node in response to determining that the firmware update is identified in a firmware compliance policy that has been validated for use by production nodes in the computer system and that the firmware update has not already been installed on the production node.

Some embodiments provide a method comprising detecting a malfunction of a production node in a computer system, identifying a firmware update that addresses the malfunction of the production node, and determining whether the firmware update is identified in a firmware compliance policy that has been validated for use by the production node. The method further comprises automatically installing the firmware update on the production node in response to determining that the firmware update is identified in a firmware compliance policy that has been validated for use by production nodes in the computer system and that the firmware update has not already been installed on the production node.

### BRIEF DESCRIPTION OF THE SEVERAL VIEWS OF THE DRAWINGS

FIG. 1 is a diagram of a computer system.

FIG. 2 is a diagram of a server.

FIG. 3 is a diagram of a system management application having various logic modules.

FIG. 4 is a firmware compliance policy for a server.

FIG. 5 is a flowchart of a method of firmware validation implemented by a system management application.

FIG. 6 is a flowchart of a method of updating firmware in response to a firmware malfunction.

### DETAILED DESCRIPTION

Some embodiments provide a computer program product comprising a non-volatile computer readable medium and non-transitory program instructions embodied therein, the program instructions being configured to be executable by a processor to cause the processor to perform operations. The operations comprise detecting a malfunction of a production node in a computer system, identifying a firmware update that addresses the malfunction of the production node, and determining whether the firmware update is identified in a firmware compliance policy that has been validated for use by the production node. The operations further comprise automatically installing the firmware update on the production node in response to determining that the firmware update is identified in a firmware compliance policy that has been validated for use by production nodes in the computer system and that the firmware update has not already been installed on the production node.

In some embodiments, the computer program product may be included in a system management application that is executable by a processor of a system management server. A system management server may be connected over a network to a computer system that includes a plurality of nodes. Each of the nodes may be managed by the system management application performed by the processor of the system management server. The nodes may include servers, multi-server chassis, switches, data storage devices and other hardware entities of a computer system. In some embodiments, the nodes may include any hardware entity that uses firmware and is capable of receiving a firmware update. In some embodiment, the nodes may include a service processor that enables out-of-band monitoring and management of the node. A non-limiting example of a service processor is a baseboard management controller. In one option, the operation of installing the firmware update on the production node includes the operation of sending the firmware update to a service processor on the production node and instructing the service processor to install the firmware update on a particular firmware component.

The system management application may monitor the operation and performance of any or all nodes in a computer system and may detect a malfunction in any known manner. For example, a malfunction may, without limitation, be detected by receiving an error code or by hanging of a workload. The system management application may perform other management functions, such as managing workloads, enforcing service level agreements, and updating firmware.

In some embodiments, the computer system may include a production system having one or more nodes or servers and a test system having one or more nodes or servers. The production system may be used to perform workloads for a client, customer or other user. The test system may be used to perform operational testing, such as testing firmware updates prior to installing those firmware updates in nodes of the production system. The test system may have hardware that is similar to the hardware in the production system, but may not include as many nodes. Accordingly, the operation of the test system under certain conditions may be representative of the operation of the production system under similar conditions. Embodiments of the test system do not require any particular degree of similarity with the production systems, but substantial differences in the hardware available in the test and production systems may decrease the value of testing. In some embodiments, the test system may include at least one server of a given type and model for each of the server types and models present in the production system.

The system management application may identify a firmware update that addresses the malfunction of the production node. Such a firmware update may be identified in a firmware repository, such as a local data storage device that contains a collection of relevant firmware updates, firmware compliance policies and troubleshooting tools. Alternatively, a firmware repository may be maintained by a node manufacturer or vendor and may be made available to end-users, such that the system management application may directly interface with the firmware repository to locate and download needed firmware updates. Such firmware repositories may include troubleshooting tools that identify a firmware update that is indicated as fixing a given firmware bug or malfunction. The system management application may obtain a given firmware update along with a firmware compliance policy that is specific to one or more node type and model. In fact, the firmware repository may provide a firmware compliance policy that identifies a firmware update level that is recommended for each firmware component of a given node type and model. In some embodiments, the system management application may obtain the firmware compliance policy as well as each of the firmware updates recommended in the firmware compliance policy. In some embodiments, the system management application may periodically poll a firmware repository for new firmware updates that are recommended for a production node of the computer system, automatically import the firmware update from the firmware repository, and automatically install and test the firmware update on a test node. The firmware compliance policy associated with the initially imported firmware update may be flagged as a “test policy.” Still further, the firmware compliance policy that recommends the firmware update may be automatically validated in response to the firmware update successfully passing the testing on the test node. Accordingly, the validated firmware compliance policy may be flagged as a “production policy” and may be applied to nodes of the production system.

When a firmware update that addresses the malfunction of the production node has been identified, the system management application may determine whether the firmware update is identified in a firmware compliance policy that has been validated for use by the production node. The terms “validated”, “validation” and other forms of these terms refer to whether or not a firmware compliance policy has been used in the test system and has been shown to function properly in the test system. Various criteria may be used to validate a firmware compliance policy. An example of a narrow validation test may include verifying that a test node with the firmware update installed does not exhibit the specific problem(s) that the firmware update was indicated to address. An example of a broader validation test may include running various workloads on the test node with the firmware update installed without experiencing an errors or hang conditions.

In some embodiments, the operations of the computer program product may further comprise automatically installing the firmware update on a test node in response to determining that the firmware compliance policy has not been validated for use by production nodes in the computer system, and operating the test node under a workload after the firmware update has been installed. In one option, the operations may further comprise validating the firmware compliance policy to be applied to production nodes in the computer system in response to determining that the test node is operating properly under a test workload after the firmware update has been installed on the test node. In another option, the operations may further comprise validating the firmware compliance policy to be applied to production nodes in the computer system in response to determining that a plurality of predetermined functions of the test node that are affected by the firmware update are operating properly under a test workload after the firmware update has been installed on the test node. Embodiments of the computer program product may prevent use of the firmware update in production nodes of the computer system until the firmware compliance policy that recommends the firmware update has been validated in the test node. Then, the validated firmware compliance policy may be used to install the firmware update in production nodes of the computer system.

In some embodiments, the system management application may assign a priority level to any one or more of a plurality of firmware compliance policies. Accordingly, firmware updates may be installed on nodes of the computer system in order of the priority level of each firmware compliance policy. If the firmware compliance policy has not yet been validated, then the “test policy” with the highest priority may be the next firmware compliance policy to be applied to the test system, meaning that firmware updates are installed so that one or more test node “complies” with the firmware compliance policy. However, it may be possible to test multiple policies in the test system at the same time. Furthermore, if the firmware compliance policy has already been validated, then the “production policy” with the highest priority may be the next firmware compliance policy to be applied to the production system, meaning that the firmware updates specified by the firmware compliance policy are installed on the specified production nodes so that the specified production nodes “comply” with the firmware compliance policy. Priority may be assigned to a firmware compliance policy based on various criteria, such as assigning a high priority to a firmware compliance policy recommending a firmware update that fixes a security hole and assigning a low priority to a firmware compliance policy recommending a firmware update that provide a marginal increase in computing capacity.

In order to ensure that there is no unplanned downtime for applications running on the production nodes, the system management application may be configured to only install firmware updates during certain hours (such as, between 2:00 AM and 4:00 AM). Accordingly, any firmware update may be delayed until the designated time period. Alternatively, if the computer system has been configured for high availability, workload may be automatically moved from a given server to a different server while a firmware update is being installed on the given server, and then the workload may be migrated back to the given server once the firmware update has been installed.

Some embodiments provide an apparatus comprising at least one non-volatile storage device storing program instructions and at least one processor configured to process the program instructions, wherein the program instructions are configured to, when processed by the at least one processor, cause the apparatus to perform operations. The operations comprise detecting a malfunction of a production node in a computer system, identifying a firmware update that addresses the malfunction of the production node, and determining whether the firmware update is identified in a firmware compliance policy that has been validated for use by the production node. The operations further comprise automatically installing the firmware update on the production node in response to determining that the firmware update is identified in a firmware compliance policy that has been validated for use by production nodes in the computer system and that the firmware update has not already been installed on the production node.

Some embodiments provide a method comprising detecting a malfunction of a production node in a computer system, identifying a firmware update that addresses the malfunction of the production node, and determining whether the firmware update is identified in a firmware compliance policy that has been validated for use by the production node. The method further comprises automatically installing the firmware update on the production node in response to determining that the firmware update is identified in a firmware compliance policy that has been validated for use by production nodes in the computer system and that the firmware update has not already been installed on the production node.

The computer program product, apparatus and method embodiments may include any one or more feature of the other embodiments described herein. For example, the apparatus and method embodiments may include any one or more feature or embodiment of the computer program product embodiments. Accordingly, a separate description of the embodiments will not be duplicated in the context of an apparatus or method.

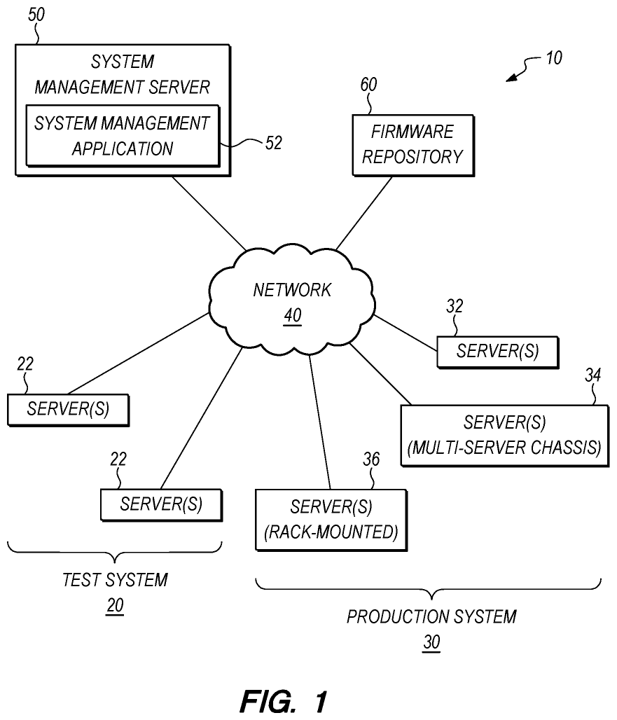

FIG. 1 is a diagram of a computer system 10 including a test system 20 and a production system 30 on the same network. In the example shown, the test system 20 may include one or more servers 22 connected to a network 40 along with the servers 32, multi-server chassis 34, and rack-mounted servers 36 of the production system 30. The test system 20 may be used to test a firmware update under a test workload before using the firmware update in the production system 30. However, embodiments may include a test system that is on separate network from the production system.

The test system 20 and the production system 30 are shown to be managed by the same system management application 52 running on the system management server 50. While only one system management application and server are shown in FIG. 1, it is also possible for the test system 20 to have a first system management application and server and for the production system to have a second system management application and server. In a computer system with separate system management applications/servers for the test system and production system, the first (test) system management application may export a validated firmware compliance policy to the second (production) system management application. Such exporting may be automatic after validation of the firmware compliance policy, or may be subject to final approval by a system administrator (personnel) prior to export.

The system management server 50 may access one or more firmware repository 60 to obtain firmware updates, obtain firmware compliance policies, and access troubleshooting tools that identify a firmware update that is indicated as fixing a given firmware bug or malfunction. The firmware repository 60 may be maintained on a local storage device or node, or the firmware repository may maintained on one or more remote vender server.

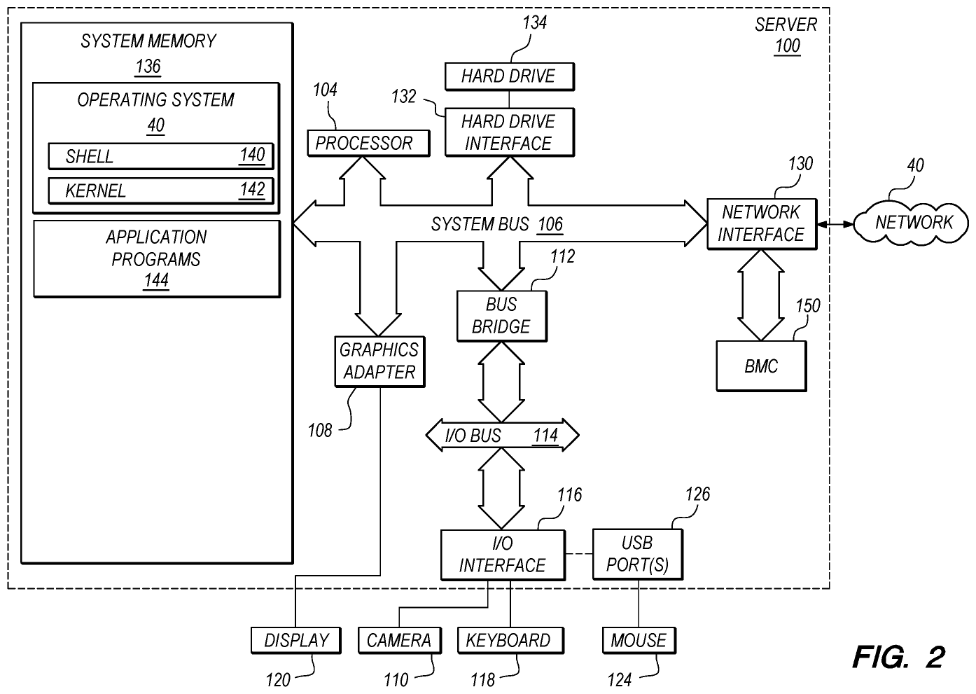

FIG. 2 is a diagram of one embodiment of a server 100 that may be included in the system 10 of FIG. 1. The server may be representative of a system management server 50, a managed server 22, 32, 34, 36, or a server providing the firmware repository 60. The server 100 includes a processor unit 104 that is coupled to a system bus 106. The processor unit 104 may utilize one or more processors, each of which has one or more processor cores. An optional graphics adapter 108, which may drive/support an optional display 120, is also coupled to system bus 106. The graphics adapter 108 may, for example, include a graphics processing unit (GPU). The system bus 106 may be coupled via a bus bridge 112 to an input/output (I/O) bus 114. An I/O interface 116 is coupled to the I/O bus 114, where the I/O interface 116 affords a connection with various optional I/O devices, such as a camera 110, a keyboard 118 (such as a touch screen virtual keyboard), and a USB mouse 124 via USB port(s) 126 (or other type of pointing device, such as a trackpad). As depicted, the computer 100 is able to communicate with other network devices over the network 40 using a network adapter or network interface controller 130. For example, the computer 100 may be a system management server and communicate with a remote server that stores a firmware repository as well as with the managed servers or other nodes in the test system and the production system.

A hard drive interface 132 is also coupled to the system bus 106. The hard drive interface 132 interfaces with a hard drive 134. In a preferred embodiment, the hard drive 134 may communicate with system memory 136, which is also coupled to the system bus 106. The system memory may be volatile or non-volatile and may include additional higher levels of volatile memory (not shown), including, but not limited to, cache memory, registers and buffers. Data that populates the system memory 136 may include the operating system (OS) 138 and application programs 144. The hardware elements depicted in the computer 100 are not intended to be exhaustive, but rather are representative.

The operating system 138 includes a shell 140 for providing transparent user access to resources such as application programs 144. Generally, the shell 140 is a program that provides an interpreter and an interface between the user and the operating system. More specifically, the shell 140 may execute commands that are entered into a command line user interface or from a file. Thus, the shell 140, also called a command processor, is generally the highest level of the operating system software hierarchy and serves as a command interpreter. The shell may provide a system prompt, interpret commands entered by keyboard, mouse, or other user input media, and send the interpreted command(s) to the appropriate lower levels of the operating system (e.g., a kernel 142) for processing. Note that while the shell 140 may be a text-based, line-oriented user interface, the present invention may support other user interface modes, such as graphical, voice, gestural, etc.

As depicted, the operating system 138 also includes the kernel 142, which includes lower levels of functionality for the operating system 138, including providing essential services required by other parts of the operating system 138 and application programs 144. Such essential services may include memory management, process and task management, disk management, and mouse and keyboard management. In addition, the computer 100 may include application programs 144 stored in the system memory 136. For example, where the computer 100 is a system management server, the system memory may include a system management application.

Still further, the server 100 may include a service processor, such as the baseboard management controller (BMC) 150. The BMC is considered to be an out-of-band controller and may monitor and control various components of the server. However, the BMC may communicate with the system management server via the network interface 130 and network 40, such as communicating the occurrence of node malfunctions and receiving firmware updates for one or more component of the server.

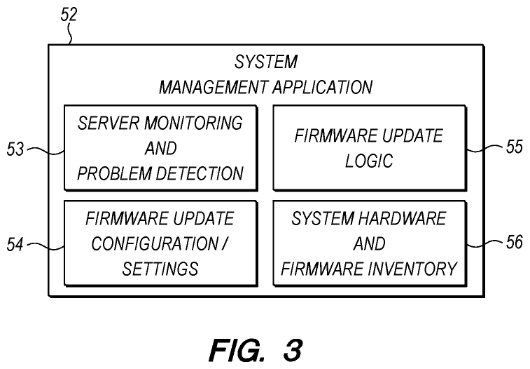

FIG. 3 is a diagram of a system management application 52 having various logic modules. In some embodiments, the system management application 52 may include a server monitoring and problem detection module 53, a firmware update configuration and settings module 54, a firmware update logic module 55, and a system hardware and firmware inventory module 56.

The server monitoring and problem detection module 53 communicates with the servers and other nodes of the computer system to monitor their operation or performance, specifically including the detection of problems, error conditions or malfunctions. In some embodiments, the server monitoring and problem detection module 53 may obtain information about the node operation or performance through communication with the operating system of the node or a service processor of the node. Furthermore, the server monitoring and problem detection module 53 may poll the node for information and/or the node may be configured to automatically report information. Both the nodes in the test system and the node in the production system may be monitored by the server monitoring and problem detection module 53.

The firmware update configuration and settings module 54 may provide an interface allowing a system administrator to customize how the system management application will perform firmware updates. For example, the firmware update configuration and settings module 54 may allow the system administrator to identify the nodes to be managed, identify whether nodes are in the test system or the production system, identify the location of one or more firmware repositories, select a setting for either proactive or reactive download and testing of new firmware updates, designate the test conditions that should be used to validate a firmware update, and optionally assign a priority to one or more firmware compliance policy or the firmware compliance policies for one or more node.

The firmware update logic module 55 may obtain firmware updates, instruct the test system to test and validate the firmware update, and install validated firmware updates on nodes in the production system. Where the firmware updates are given a priority, the firmware update logic module 55 may organize the firmware updates to occur in priority order. Furthermore, the firmware updates may be scheduled to avoid interruptions in availability of the nodes.

The system hardware and firmware inventory module 56 may collect and maintain a current list of all hardware and firmware in the computer system. The list may further include, for each node, hardware type and model information necessary to identify compatible firmware and a record of the current firmware version installed on firmware components of the node. This information may be stored by the system management application along with other node information used to perform other system management functions.

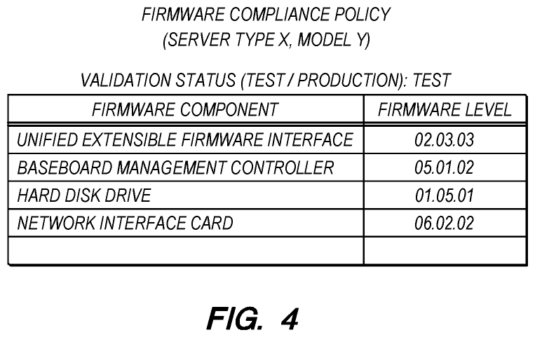

FIG. 4 is a diagram of a firmware compliance policy for a given server. A compliance policy may be obtained from a firmware repository and may be specific to a particular node type and model, such as a particular server type and model. The compliance policy may be obtained from the same source as the firmware updates themselves. The firmware compliance policy for a given node type and model may identify firmware updates that are recommended to be installed on the nodes of the given type and model. Accordingly, the compliance policy may include a plurality of records (illustrated as rows of the table), where each record identifies a firmware component of the given node and identifies the firmware level that is compatible or recommended for the firmware component. Non-limiting examples of the firmware components of a given server may include a Unified Extensible Firmware Interface (UEFI), a Baseboard Management Controller (BMC), a hard disk drive (HDD), and a network interface card (NIC). Due to differences in hardware features and configuration, hardware capacity, and other characteristics, all nodes are not necessarily compatible with the latest firmware updates.

The firmware compliance policy shown in FIG. 4 is specific to a server of Type X and Model Y. Since the firmware compliance policy typically originates from the node vendor, the firmware compliance policy is developed by the vendor with full understanding of the firmware components of the node and may be published following testing by the vendor.

In accordance with some embodiments, the firmware compliance policy has been flagged with a validation status of “test” or “production”, where the “test” flag means that the firmware compliance policy is only approved for use within the test system and the “production” flag means that the firmware compliance policy is approved for use within the production system. A firmware compliance policy associated with a newly imported firmware update may be initially flagged with a test status, then switched to a production status in response to the firmware update being validated in the test system. The validation status may be automatically changed by the system management application if automatic validation has been selected by the system administrator. Alternatively, the system management application may notify the system administrator that a firmware update has completed testing in the test system and prompt the system administrator to either accept or deny validation of the firmware update.

The conditions that must be satisfied in the test system before a firmware update is validated for use in the production system may vary depending upon the important functions of the firmware or the important functions of the firmware component that receives the firmware update. For example, the firmware update may be installed on a test system and subjected to a regression test to verify that the main functions of the firmware or device continue to work fine after the firmware update.

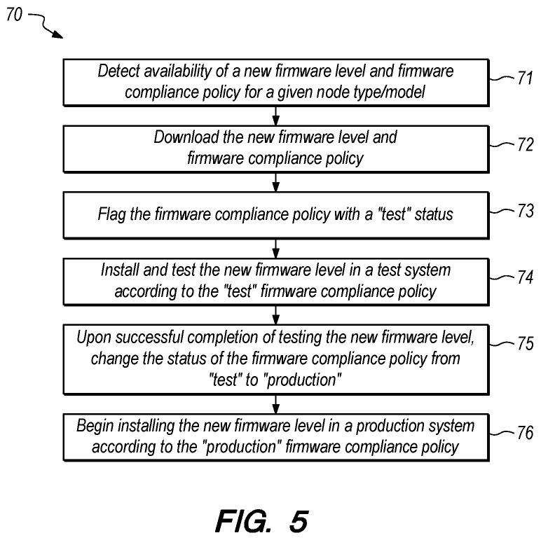

FIG. 5 is a flowchart of a method 70 of firmware validation implemented by a system management application. The firmware validation method may be run proactively to test and validate firmware updates as they become available in a firmware repository. For example, the method may actively identify and download firmware updates relevant to any of the firmware components of a node in the computer system, then automatically initiate validation of any downloaded firmware updates in a test node. A validated firmware update is then ready to be deployed as needed in the production environment of the computer system.

In step 71, the method detects availability of a new firmware level and firmware compliance policy for a given node type/model. The method may detect availability of a new firmware level by periodically polling a firmware repository. In a proactive mode of the system management application, the given node type/model may be any or every node type/model within the computer system. In step 72, the method downloads the new firmware level and firmware compliance policy. The firmware update/level and compliance policy may be initially downloaded to the system management server or downloaded directly to the node(s) that the system management server wants to update. In step 73, the method flags the firmware compliance policy with a “test” status. In step 74, the method installs and tests the new firmware update/level in a test system according to the “test” firmware compliance policy. Step 75 changes the status of the firmware compliance policy from “test” to “production” upon successful completion of testing the new firmware level. In step 76, the method begins installing the new firmware level in a production system according to the “production” firmware compliance policy.

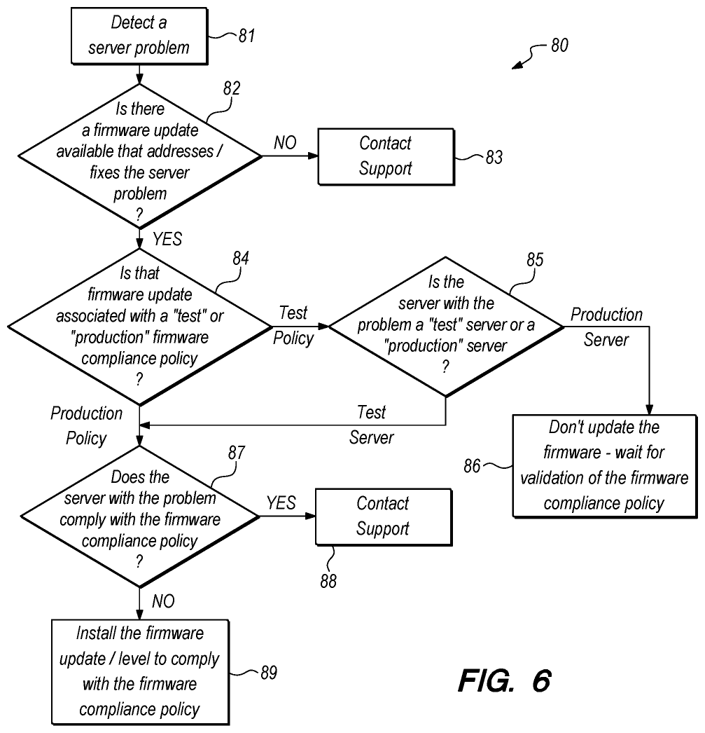

FIG. 6 is a flowchart of a method 80 of updating firmware in response to a firmware malfunction. In step 81, the method detects a server problem. One example of a server problem is a firmware malfunction, such as a memory leak or a null pointer exception that causes the firmware to stop functioning. In step 82, the method determines whether there is a firmware update or level available that addresses or fixes the server problem. If no such firmware update is available, then the method may contact support in step 83.

If step 82 determines that a firmware update is available to address or fix the server problem, then step 84 determines whether that firmware update is associated with a “test” or “production” firmware compliance policy. A “test” firmware compliance policy has not yet been validated for use in the production system as a “production” firmware compliance policy. If step 84 determines that the firmware compliance policy is a “test” policy, then step 85 determines whether the server with the problem is a “test” server or a “production” server.” A “test” server is a server in the test system and a “production” server is a server in the production system. If step 85 determines that the server with the problem is a “production” server, then the firmware is not updated in step 86. Rather, step 86 includes waiting for validation of the firmware compliance policy before the firmware update may be installed on the production server.

On the other hand, if step 85 determines that the server with the problem is a “test” server, then step 87 determines whether the server with the problem complies with the firmware compliance policy. If step 87 determines that the server with the problem complies with the firmware compliance policy, then step 88 contacts support. Step 88 represents that situation where a production firmware compliance policy has already been applied to a production server, yet the server has experienced a problem. Therefore, there are no other firmware fixes known at the time, such that support should be contacted. However, if step 87 determines that the server with the problem does not comply with the firmware compliance policy, then step 89 installs the firmware update/level in order to be in compliance with the firmware compliance policy.

In reference to both FIGS. 5 and 6, the firmware validation process of FIG. 5 may be proactively implemented such that a firmware update is tested and validated in method 70 before a server problem (i.e., firmware malfunction) is detected in method 80 of FIG. 6. In this situation, the two processes may run sequentially as to a particular firmware compliance policy. However, it is also possible that a server problem (i.e., firmware malfunction) may occur while the firmware validation process 70 of FIG. 5 has not yet completed. In this second situation, the process of FIG. 6 may be paused until the validation process for the firmware compliance policy associated with the needed firmware update has been completed. This pause may, for example, occur at step 86 of method 80. If the firmware compliance policy is subsequently validated, then the firmware compliance policy may be applied to the production system such that the needed firmware update may be installed on the server having a problem in the production system.

Yet another situation may occur in which the firmware validation process 70 of FIG. 5 is implemented in response to detecting a server problem in step 81 of FIG. 6. In this situation, the process 80 may be paused after step 82 in order to run the firmware validation process 70 for a firmware update that is found to be available to fix a firmware malfunction in the server having the problem. After the relevant firmware update is identified, downloaded and successfully tested according to the process of FIG. 5 such that the associated firmware compliance policy becomes validated, then the method of FIG. 6 may continue with the next step 84.

As will be appreciated by one skilled in the art, embodiments may take the form of a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Any combination of one or more computer readable storage medium(s) may be utilized. A computer readable storage medium may be, for example, but not limited to, an electronic, magnetic, optical, electromagnetic, infrared, or semiconductor system, apparatus, or device, or any suitable combination of the foregoing. Non-limiting examples of the computer readable storage medium may include the following: a portable computer diskette, a hard disk drive, a random access memory (RAM), a read-only memory (ROM), an erasable programmable read-only memory (EPROM or Flash memory), a portable compact disc read-only memory (CD-ROM), a digital optical disc, or any suitable combination of the foregoing. In the context of this document, a computer readable storage medium may be any non-transitory, tangible medium that can contain, or store a program for use by or in connection with an instruction execution system, apparatus, or device. Furthermore, any program instruction or code that is embodied on such computer readable storage media is non-transitory.

Program code embodied on a non-transitory computer readable storage medium may be transmitted using any appropriate medium, including but not limited to wireless, wireline, optical fiber cable, RF, etc., or any suitable combination of the foregoing. Computer program code for carrying out various operations may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Embodiments may be described with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, and/or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may be stored on a non-transitory computer readable storage media, such that the program instructions can direct a computer, other programmable data processing apparatus, or other devices to function in a particular manner, and such that the computer readable storage medium storing the program instructions is an article of manufacture.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to limit the scope of the claims. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the embodiment.

The corresponding structures, materials, acts, and equivalents of all means or steps plus function elements in the claims below are intended to include any structure, material, or act for performing the function in combination with other claimed elements as specifically claimed. Embodiments have been presented for purposes of illustration and description, but it is not intended to be exhaustive or limited to the embodiments in the form disclosed. Many modifications and variations will be apparent to those of ordinary skill in the art after reading this disclosure. The disclosed embodiments were chosen and described as non-limiting examples to enable others of ordinary skill in the art to understand these embodiments and other embodiments involving modifications suited to a particular implementation.

1. A computer program product comprising a non-transitory computer readable storage medium and non-transitory program instructions embodied therein, the program instructions being configured to be executable by a processor to cause the processor to perform operations comprising:
detecting a malfunction of a production node in a computer system;
identifying a firmware update that addresses the malfunction of the production node;
determining whether the firmware update is identified in a firmware compliance policy that has been validated for use by the production node; and
automatically installing the firmware update on the production node in response to determining that the firmware update is identified in a firmware compliance policy that has been validated for use by production nodes in the computer system and that the firmware update has not already been installed on the production node.

2. The computer program product of claim 1, wherein the firmware compliance policy identifies the firmware update as being recommended for the production node.

3. The computer program product of claim 1, the operations further comprising:
automatically installing the firmware update on a test node in response to determining that the firmware compliance policy has not been validated for use by production nodes in the computer system; and
operating the test node under a workload after the firmware update has been installed.

4. The computer program product of claim 3, the operations further comprising:
validating the firmware compliance policy to be applied to production nodes in the computer system in response to determining that the test node is operating properly under a test workload after the firmware update has been installed on the test node.

5. The computer program product of claim 3, the operations further comprising:
validating the firmware compliance policy to be applied to production nodes in the computer system in response to determining that a plurality of predetermined functions of the test node that are affected by the firmware update are operating properly under a test workload after the firmware update has been installed on the test node.

6. The computer program product of claim 1, the operations further comprising:
obtaining the firmware update from a firmware repository.

7. The computer program product of claim 6, the operations further comprising:
obtaining the firmware compliance policy from the firmware repository

8. The computer program product of claim 1, the operations further comprising:
preventing use of the firmware update in production nodes of the computer system until the firmware compliance policy has been validated in the test node; and
using the firmware compliance policy to update firmware in production nodes of the computer system after the firmware compliance policy has been validated.

9. The computer program product of claim 1, the operations further comprising:
periodically polling a firmware repository for updated firmware;
automatically importing updated firmware from the firmware repository; and
automatically installing and testing the firmware update on a test node.

10. The computer program product of claim 9, the operations further comprising:
automatically validating a compliance policy that recommends the firmware update in response to the firmware update successfully passing the testing on the test node.

11. The computer program product of claim 1, the operations further comprising:
assigning a priority level to each of a plurality of firmware compliance policies that have been validated; and
installing firmware updates on nodes of the computer system in order of the priority level of each firmware compliance policy.

12. The computer program product of claim 1, wherein the operation of installing the firmware update on the production node includes the operation of sending the firmware update to a service processor on the production node and instructing the service processor to install the firmware update, wherein the service processor performs out-of-band monitoring and management of the production node.

13. The computer program product of claim 1, wherein the test node and the production node both have a node type and a node model associated with the firmware compliance policy.

14. The computer program product of claim 1, wherein the production node is a server or a switch.

15. An apparatus, comprising:
at least one non-volatile storage device storing program instructions; and
at least one processor configured to process the program instructions,
wherein the program instructions are configured to, when processed by the at least one processor, cause the apparatus to perform operations comprising:
detecting a malfunction of a production node in a computer system;
identifying a firmware update that addresses the malfunction of the production node;
determining whether the firmware update is identified in a firmware compliance policy that has been validated for use by the production node; and
automatically installing the firmware update on the production node in response to determining that the firmware update is identified in a firmware compliance policy that has been validated for use by production nodes in the computer system and that the firmware update has not already been installed on the production node.

16. The apparatus of claim 15, the operations further comprising:
automatically installing the firmware update on a test node in response to determining that the firmware compliance policy has not been validated for use by production nodes in the computer system; and
operating the test node under a workload after the firmware update has been installed.

17. The apparatus of claim 16, the operations further comprising:
validating the firmware compliance policy for use by production nodes in the computer system in response to determining that the test node is operating properly under a test workload after the firmware update has been installed on the test node.

18. The apparatus of claim 15, the operations further comprising:
periodically polling a firmware repository for updated firmware;
automatically importing updated firmware from the firmware repository; and
automatically installing and testing the firmware update on a test node.

19. The apparatus of claim 18, the operations further comprising:
automatically validating a compliance policy that recommends the firmware update in response to the firmware update successfully passing the testing on the test node.

20. A method comprising:
detecting a malfunction of a production node in a computer system;
identifying a firmware update that addresses the malfunction of the production node;
determining whether the firmware update is identified in a firmware compliance policy that has been validated for use by the production node; and
automatically installing the firmware update on the production node in response to determining that the firmware update is identified in a firmware compliance policy that has been validated for use by production nodes in the computer system and that the firmware update has not already been installed on the production node.
